(19) United States
(12) Patent Application Publication
(10) Pub. No.: US 2001/0002219 A1
(43) Pub. Date: May 31, 2001

(54) Multi-branching optical coupler

(75) Inventors: Tsuneo Mori, Gunma (JP); Masaaki Shirota, Gunma (JP); Kazuo Koya, Gunma (JP); Sayuri Maeda, Gunma (JP); Seiki Ejima, Gunma (JP)

Correspondence Address: Pillsbury Madison & Sutro LLP, Intellectual Property Group, East Tower, Ninth Floor, 1100 New York Avenue, N.W., Washington, DC, 20005-3918, US

(73) Assignee: Shin-Etsu Chemical Co., Ltd.

(21) Appl. No.: 09/749,571

(22) Filed: Dec. 28, 2000

Related U.S. Application Data
(62) Division of application No. 09/106,846, filed on Jun. 30, 1998.

(30) Foreign Application Priority Data
Jun. 30, 1997 (JP) H09-173371
Sep. 30, 1997 (JP) H09-266244

(51) Int. Cl. G02B 6/26; G02B 6/42

(52) U.S. Cl. 385/46; 385/39

(57) ABSTRACT

A multi-branching optical coupler outputs input light by branching the input light into multiple fibers. This multi-branching optical coupler has a center fiber positioned at the center of the multiple fibers and multiple surrounding fibers installed around the circumference of the center fiber such that the distance between any two adjacent surrounding fibers is substantially constant. The light input to the input end of the center fiber is branched into the output end of the center fiber and the surrounding fibers. The center fiber has a core that extends from the input end to the output end, and a clad formed around the core. The totality of fibers has a coupled region in which all of the surrounding fibers are fused to the center fiber. The center fiber and the surrounding fibers may be installed substantially parallel to each other and linearly. As an alternative, the surrounding fibers may be twisted co-axially about the center fiber. The center fiber and the surrounding fibers are heated and drawn so that they become partial cones. Each of these partial cones forms a tapered portion. The totality of the tapered portions forms a tapered portion. The tapered portion is connected to each of the two ends of the coupled region in the axial direction. One of the two ends of each of the surrounding fibers is made non-reflective. The light that has branched out of the other of the two ends of each of the surrounding is output.

### BACKGROUND OF THE INVENTION

1. Field of the Invention

The present invention relates to a multi-branching optical coupler for branching input light to a plurality of optical fibers.

2. Description of the Related Art

With the rapid progress of optical fiber transmission technology, optical data links, which utilize optical fibers for transmitting data between computers or between a computer and a terminal, have been the subject of much research and development. In configuring such an optical data link, a multi-branching optical coupler, which is capable of mixing light signals from multiple input optical fibers and distributing the mixed light signals evenly and with a low loss to multiple output optical fibers, is an essential device. The optical star coupler disclosed in Japanese Patent Application Laid-Open No. 60-24505 and the optical star coupler disclosed in Japanese Patent Application Laid-Open No. 63-205616 are examples of such a multi-branching optical coupler.

The optical star coupler disclosed in Japanese Patent Application Laid-Open No. 60-24505 is manufactured by inserting an optical fiber bundle into a glass tube, and heating and drawing the glass tube so that the optical fibers are substantially evenly arranged with respect to the center of the coupler. The optical star coupler disclosed in Japanese Patent Application Laid-Open No. 63-205616 is manufactured by coupling multiple 3 dB optical couplers in multi-stages, realizing many branch points.

In the case of the former optical coupler, the optical fibers are arranged symmetrically about the center of the coupler. However, in this case, since no fiber exists at the center, the symmetry with respect to the injection port is poor. As a result, it is difficult to achieve equi-branching characteristics. In the case of the latter optical coupler, unlike a batch fuse type coupler, several couplers have been coupled in multi-stages to form the optical star coupler. As a result, the overall size of the optical star coupler is significantly increased.

Another optical fiber type star coupler disclosed in Japanese Patent Application Laid-Open No. 63-70208 is manufactured by twisting, fusing, and drawing an optical fiber bundle, and covering the optical fiber bundle with a glass tube. However, in this optical fiber type star coupler, the initial arrangement of the fibers is not preserved after the twisting, fusing, and drawing process. As a result, the variance of the intensities of the light output from the fibers is hard to control. Therefore, in this case, it is difficult to achieve equi-branching characteristics.

In addition, a multi-branching optical coupler having four branches disclosed in OEC 1994 pp364 is manufactured arranging five fibers on a plane taking symmetry into consideration. In this case, one of these fibers does not contribute to the outputs. This fiber is difficult to produce. Moreover, since the five fibers are arranged horizontally in a row, the width of the coupler is increased. As a result, the size of the coupler case is increased significantly also.

In addition, a method for manufacturing a fiber optic coupler and a 1×N fiber optic coupler is disclosed in Japanese Patent Application Laid-Open No. H7-140346. According to this method, N fibers are first inserted into a glass tube. The glass tube is then heated and drawn, collapsing the entire glass tube. This method involves a process for putting the fibers into the glass tube, and a process for collapsing the entire glass tube. It is not easy to manufacture these couplers due to these manufacturing processes. In addition, it is extremely difficult to collapse the entire glass tube without distorting the fibers. Moreover, the collapsed fibers are deformed, in which case, the light transmission properties of the fibers, for example, the polarized wave dependency, can be adversely affected.

### SUMMARY OF THE INVENTION

Given the above-described problems, it is an object of the present invention to provide an equally multi-branching optical coupler, which is simply structured and compact.

According to the first aspect of the present invention, the multi-branching optical coupler has a center fiber having an input end from which the light is input and an output end from which the light is output. Multiple surrounding fibers are installed around the center fiber. The light input to the input end of the center fiber is branched into the output end of the center fiber and the surrounding fibers. According to the second aspect of the present invention, the center fiber has a core, which extends from the input end to the output end and a clad installed on the circumference of the core.

According to the third aspect of the present invention, each of the surrounding fibers has a coupled region that is fused with the center fiber. According to the fourth aspect of the present invention, the surrounding fibers are placed on the circumference of the center fiber such that each successive two of the surrounding fibers are arranged by substantially the same distance. According to the fifth aspect of the present invention, the center fiber and the surrounding fibers are installed substantially parallel and linearly. According to the sixth aspect of the present invention, the surrounding fibers are twisted in the coupled region about the center fiber while keeping the distance between each successive two of the surrounding fibers constant. According to the seventh aspect of the present invention, the multi-branching optical coupler further has a tapered portion that is installed outside of the coupled region in the axial direction, the tapered portion having a partial cone shaped center fiber and partial cone shaped surrounding fibers, which have been formed by drawing the center fiber and surrounding fibers, respectively.

According to the eighth aspect of the present invention, each of the surrounding fibers has two ends, one of the two ends being made non-reflective, and the branched light being output from the other of the two ends. According to the ninth aspect of the present invention, each of the surrounding fibers has two ends, the multi-branching optical coupler further having a tape-type fiber connected to one of the two ends. According to the tenth aspect of the present invention, at least one of the surrounding fibers is fused with at least one of the other surrounding fibers. According to the eleventh aspect of the present invention, none of the surrounding fibers is fused with any of the other surrounding fibers.

According to the twelfth aspect of the present invention, each of the surrounding fibers has a core and a clad installed on the circumference of the core and a coupled region in which the clad of each of the surrounding fibers is fused with the clad of the center fiber. According to the thirteenth aspect of the present invention, the total number of fibers is greater than or equal to eight, and the clad diameter CLDc of the center fiber is larger than the clad diameter CLDs of the respective surrounding fiber.

According to the fourteenth aspect of the present invention, the multi-branching optical coupler further has an extension region in which the center fiber and surrounding fibers are not drawn. In this case, the surrounding fibers are not fused with the center fiber outside of the coupled region in the axial direction, and in the extension region. Moreover, the clad diameter CLDc of the center fiber, the clad diameter CLDs of the respective surrounding fiber, and the total number of fibers n satisfy the relation.

0≦CLDc−(CLDs/sin(π/(n−1))+CLDs≦100 μm.

According to the fifteenth aspect of the present invention, the center fiber has a base fiber including a core and a clad installed on the circumference of the core, the clad diameter of the base fiber being smaller than the clad diameter CLDc of the center fiber, and a transparent pipe tightly attached to the circumference of the base fiber, the diameter of the transparent pipe being equal to the clad diameter CLDc of the center fiber, and the refractive index of the transparent pipe is less than or equal to the refractive index of the clad of the base fiber. According to the sixteenth aspect of the present invention, each of the surrounding fibers is manufactured from a fiber having the same clad diameter as the clad diameter of the center fiber by reducing the clad diameter of the fiber.

According to the seventeenth aspect of the present invention, the clad diameter of each of the surrounding fibers is reduced by heating and drawing the respective surrounding fiber. According to the eighteenth aspect of the present invention, the clad diameter of the respective surrounding fiber is reduced by etching by a chemical process the clad of the respective surrounding fiber. According to the nineteenth aspect of the present invention, the cutoff wavelength of the center fiber is substantially equal to the cutoff wavelength of the respective surrounding fiber. According to the twentieth aspect of the present invention, the propagation constant of the center fiber is substantially equal to the propagation constant of the respective surrounding fiber.

According to the 21st aspect of the present invention, the clad diameter of the center fiber is substantially equal to the clad diameter of each of the surrounding fibers. According to the 22nd aspect of the present invention, the relative refractive index of the center fiber is substantially equal to the relative refractive index of each of the surrounding fibers. According to the 23rd aspect of the present invention, the mode field diameter of the center fiber is substantially equal to the mode field diameter of each of the surrounding fibers.

According to the 24th aspect of the present invention, the multi-branching optical coupler further has a connection fiber connected to at least one end of the center fiber. The clad diameter of the connection fiber is smaller than the clad diameter of the center fiber. According to the 25th aspect of the present invention, each of the surrounding fibers has two ends. This multi-branching optical coupler further has a connection fiber connected to at least one of the two ends, the clad diameter of the connection fiber being larger than the clad diameter of each of the surrounding fibers.

According to the 26th aspect of the present invention, one center fiber having an input side to which the light is input and an output side from which the light is output is prepared. The center fiber is extended from the input side to the output side, openable and closable regular polygonal case is opened, bending at least two successive corners of the regular polygonal case, one of the surrounding fibers is placed at each of the two successive corners, the center fiber is placed on the surrounding fibers placed at the two successive corners, the remaining surrounding fibers are placed at the remaining corners of the regular polygonal case, the regular polygonal case is closed, and the surrounding fibers are fused with the center fiber by heating and drawing the fiber bundle in the axial direction of the center fiber.

### BRIEF DESCRIPTION OF THE DRAWINGS

FIG. 1 is a cross sectional view of a multi-branching optical coupler, in which four fibers are used according to the present invention.

FIG. 2 shows the relation between the drawn length of the respective surrounding optical fiber and the intensity of the output optical power.

FIGS. 3A through 3D show a method for arranging optical fibers according to the present invention.

FIGS. 4A through 4C are examples of cross sectional views of a multi-branching optical coupler, according to the present invention.

FIGS. 5A through 5C show a transformation sequence of the cross sections of a coupled region during the heating and drawing process.

FIG. 6 shows the relation between the clad diameter difference ΔCLD and the multiformity.

FIGS. 7A and 7B show the relation between the intensity of the light output and the drawn length of the center fiber.

FIG. 8 shows a base fiber inserted into a tube.

FIG. 9 shows a multi-branching optical coupler unit being drawn.

FIG. 10 shows the relation between the insertion loss and each output port of a multi-branching optical coupler according to the present invention.

FIG. 11 shows the relation between the insertion loss at each output port of a multi-branching optical coupler according to the present invention.

### DETAILED DESCRIPTION OF THE INVENTION

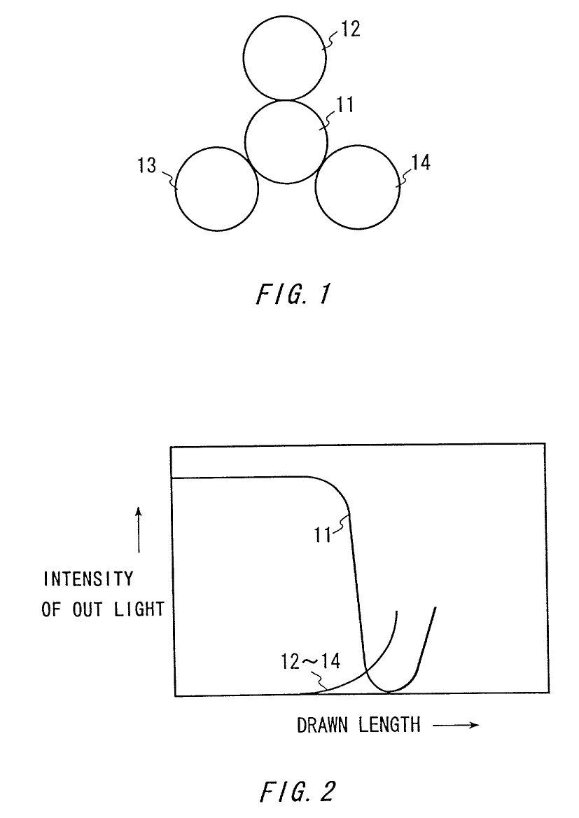

In what follows, the present invention will be explained in detail with reference to the attached drawings. First, with reference to FIG. 1, a case in which four optical fibers are used will be explained as an example. A portion of the coating that covers each of the four optical fibers is first removed. One of the fibers is selected as the center fiber 11. Next, the remaining three fibers 12, 13, and 14, which serve as surrounding fibers, are arranged around the center fiber 11. As FIG. 1 shows, the three surrounding fibers 12, 13, and 14 are separated from each other by the same distance on the circumference of the center fiber 11, forming a fiber bundle.

The fibers 11 through 14 are then heated with oxyhydrogen flame. This fiber bundle is drawn, that is, pulled and elongated, as it is heated. While the fibers are heated and drawn, monitor light is injected into the input terminal of the center fiber 11. At the same time, the output from the output terminal of the center fiber 11 and the output from arbitrary one of the surrounding optical fibers 12, 13, and 14 are monitored. This heating, fusing, and drawing process is stopped when the light branching ratio between these two outputs has become equal. In this way, an equally multi-branching optical coupler can be obtained.

FIG. 2 shows changes in the intensities of the optical power outputs from the center fiber 11, and surrounding fibers 12, 13, and 14 with respect to the lengths these fibers have been drawn. The fibers 12, 13, and 14 are arranged and separated by the same distance on the circumference of the center fiber 11, and are fused with the center fiber 11. Therefore, as FIG. 2 shows, the optical power outputs from the output terminals of the fibers 12 through 14 become equal to one another. Accordingly, if the heating, fusing, and drawing process is stopped when the optical power output from the fiber 11 has become equal to that from any of the three surrounding fibers 12 through 14, the light can be branched equally into all the output fibers.

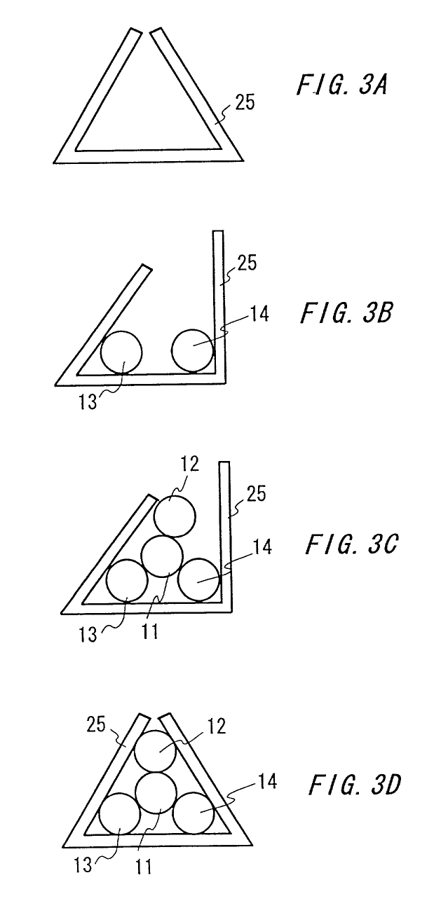

Next, a method for manufacturing a multi-branching optical coupler of another type according to the present invention will be explained with reference to FIGS. 3, 4 and 5. In this case, the surrounding fibers 12, 13, and 14 may be arranged parallel to the center fiber 11 without twisting the surrounding fibers 12, 13, and 14 around the center fiber 11. In this case also, by separating the surrounding fibers 12, 13, and 14 from each other by an equal distance on the circumference of the center fiber 11, it becomes possible to obtain a multi-branching optical fiber which branches the injected light into all the output fibers (the center fiber 11 and the surrounding fibers 12, 13, and 14) with the same ratio. Thus, in the case in which the surrounding fibers 12, 13, and 14 are installed parallel around the center fiber 11 separating the surrounding fibers 12, 13, and 14 by the same distance without being twisted, the surrounding fibers 12, 13, and 14 can be easily arranged evenly at the initial stage before fusing the surrounding fibers with the center fiber 11.

FIG. 3 shows a jig 25 for arranging three surrounding fibers 12, 13, and 14 evenly around a center fiber 11 so that the three surrounding fibers 12, 13, and 14 will be separated by the same distance. This jig 25 is a thin, long tube-shaped regular polygonal case that is, the cross section of the case forms a regular polygon when it is closed (an equilateral triangular case in FIG. 3). As FIG. 3A shows, at least one side of this jig can be freely closed and opened. When this jig 25 is closed, the area enclosed by the cross section of the jig 25 forms an equilateral triangle. Hereafter, such a jig will be called an equilateral triangular jig.

When m (m≦3) surrounding fibers are installed around a center fiber 11, a regular m-gonal jig is used, that is, the area enclosed by the cross section of the jig forms a regular polygon with m sides. As FIG. 3B shows, first, the top two sides of the jig 25 are opened and the surrounding fibers 13 and 14 are placed at the two bottom corners of the jig 25, respectively. The fiber 11 is then placed on and between the fibers 13 and 14. Next, as FIG. 3C shows, the last fiber 12 is placed on the fiber 11. Next, as FIG. 3D shows, the jig 25 is closed so that the fibers 12 through 14 will be placed evenly on the circumference of the center fiber 11.

When the jig is a regular m-gonal case, where m≦4, two successive corners of the regular m-gonal case is bent to open the jig. One of the surrounding fibers are first placed at the two successive corners. The center fiber is then placed on the surrounding fibers placed at the two successive corners. The remaining surrounding fibers are placed at the remaining corners of the regular polygonal case. The regular n-gonal case is then closed.

Next, this fiber bundle is pulled out from the jig 25. By the same method as described in the above, light is supplied to the input terminal side of the center fiber 11, and the light output from the output terminal side of the center fiber 11 and the light output from one of the surrounding fibers 12 through 14 are monitored as the fiber bundle is heated and drawn. The drawing process is stopped when the intensity of the light output from the center fiber 11 becomes equal to the intensity of the light output from the monitored surrounding fiber. In this way, an equally multi-branching optical coupler can be obtained. In the previously-described example above, the case in which four optical fibers (n=4) are used, that is, the branching number is four, was explained with reference to FIGS. 1 and 2. Also when the branching number, i.e, the total number n of surrounding fibers and the center fiber is n≦5, the above-described method can be used to manufacture an equally multi-branching optical coupler using a regular (n−1) -gonal jig based on the method for arranging more than four surrounding fibers described in the above.

When n is greater than or equal to eight (when seven or more surrounding fibers are used), in order to bring all the surrounding fibers into contact with the circumference of the center fiber, the clad diameter of the center fiber must be made larger than that of each of the surrounding fibers. When n is greater than or equal to eight, if the clad diameter of each surrounding fiber is denoted by CLDs, the minimum required value of CLDc(min) is expressed by the following equation (1).

CLDc(min)=(CLDs/sin(π/(n−1))−CLDs (1)

In accordance with equation (1), if n=8, and the clad diameter of each of the surrounding fibers is 125 μm, the clad diameter of the center fiber 11 must be larger than 163 μm. For example, if the clad diameter of the center fiber 11 is 168 μ m, then all the surrounding fibers can be tightly attached to the center fiber 11.

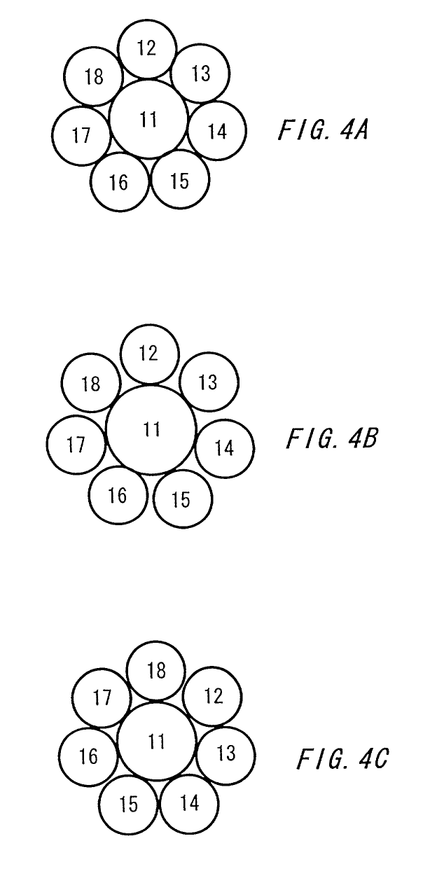

FIGS. 4A through 4C show cross sections of a (1 input) ×(8 output) multi-branching optical coupler according to the present invention before the fibers are heated and drawn. The center fiber 11 is fused with each of the surrounding fibers 12 through 18 in order to branch injected light from the center fiber 11 to the surrounding fibers 12 through 18. In FIG. 4A, each of the surrounding fibers 12 through 18 is in contact with its neighboring surrounding fibers. However, as FIG. 4B shows, the surrounding fibers 12 through 18 maybe separated from each other.

If the surrounding fibers 12 through 18 are arranged evenly on the circumference of the center fiber 11, the variation between the intensities of the light output from the respective fibers can be reduced. However, temperature discrepancies between the fibers arise while the fiber bundle is being heated. In addition, when the fibers are drawn, the tensile strength of the respective fibers against the drawing differ from one another. Therefore, even if the surrounding fibers 12 through 18 are arranged evenly on the circumference of the center fiber 11, the surrounding fibers 12 through 18 may be displaced from their initial positions by these factors. In order to prevent this problem, the fiber bundle is twisted around the center fiber.

In this way, the surrounding fibers 12 through 18 are pressed onto the center fiber 11. As a result, the surrounding fibers 12 through 18 remain tightly attached onto the circumference of the center fiber 11 while the fiber bundle is being heated and drawn. FIG. 4C shows another cross section of the fiber bundle at a different point in the axial direction. In this case, the fiber bundle has been twisted around the center fiber. As a result, the surrounding fibers 12 through 18 have been wound around the center fiber 11. In this case, as FIG. 4C shows, at a different point in the axial direction, the positions of the surrounding fibers 12 through 18 on the cross section plane are rotated with respect to the center of the center fiber 11 as the fiber bundle is twisted.

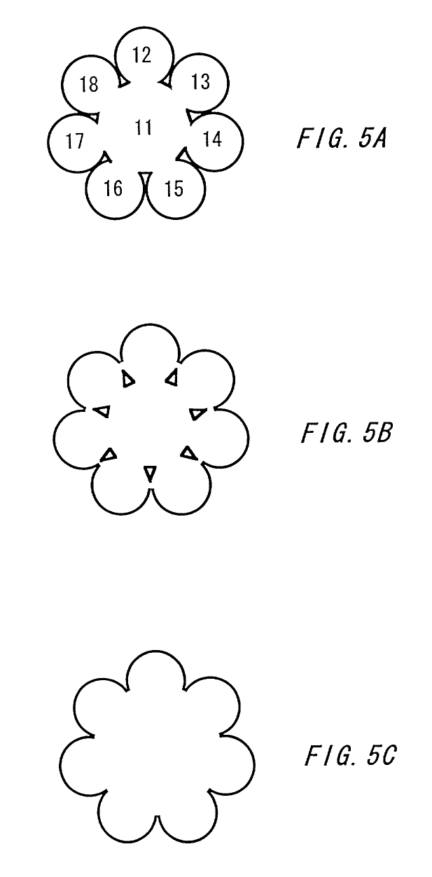

FIGS. 5A through 5C show a transformation sequence of the cross section of the coupler shown in FIG. 4C which occurs during the heating and drawing process. In FIG. 5A, the surrounding fibers 12 through 18 are fused to the center fiber 11. However, the surrounding fibers 12 through 18 are still separated from each other. In FIG. 5B, the fiber bundle has been further drawn. As a result, each of the surrounding fibers 12 through 18 has been fused with its neighboring surrounding fibers. However, at this stage, a small gap still remains between neighboring surrounding fibers. FIG. 5C shows a state in which each of the surrounding fibers 12 through 18 has become completely fused with its neighboring surrounding fibers and the above-mentioned gap has disappeared.

During these heating and drawing processes, the output from the center fiber and the output from one of the surrounding fibers are monitored. The drawing process is stopped when the intensity of the light output from the center fiber has become equal to the intensity of the light output from the monitored surrounding fiber. The state of the surrounding fibers 12 through 18 when the drawing process is completed may be any of the state shown in FIG. 5A in which each of the surrounding fibers 12 through 18 is not fused any of its neighboring surrounding fiber, or the state shown in FIG. 5B in which a small gap remains between successive surrounding fibers, or the state shown in FIG. 5C in which all the gaps between the successive surrounding fibers have been eliminated. Even when the clad diameter of the center fiber 11 differs from that of the respective surrounding fiber, it is desirable that the propagation constant βC of the center fiber be close to the propagation constant βS of the surrounding fiber

If the clad diameter of the center fiber is increased beyond a certain value, a gap is created between each pair of neighboring surrounding fibers before the fiber bundle is heated and drawn. In this case, the clad diameter difference ΔCLD between actual clad diameter CLDc of the center fiber and the minimum clad diameter CLDc(min) of the center fiber, which does not make any distance between adjacent surrounding fibers, is expressed by the following equation (2).

ΔCLD=CLDc−CLDc(min) =CLDc−(CLDs/sin(π/(n−1))+CLDs (2)

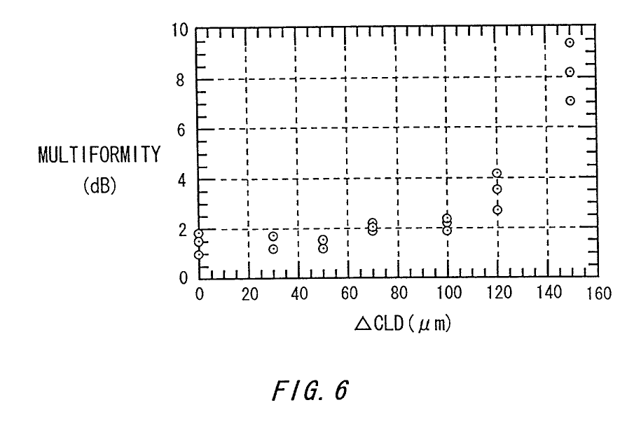

FIG. 6 shows an experimentally determined relation between the change in multiformity and the change in the clad diameter difference ΔCLD. Here, “multiformity” represents the multiformity of the light that is transmitted to each output fiber, and is equal to the difference between the maximum output optical power loss and the minimum output optical power loss with respect to the input optical power. If the clad diameter difference ΔCLD is too large, the variations among the light output intensities of the n fibers (the multiformity) become large. In particular, once the clad diameter difference ΔCLD becomes larger than approximately 100 μm, the multiformity rapidly grows. The degree of freedom of arrangement increases as the gap between each pair of neighboring surrounding fibers increases. As a result, the surrounding fibers are arranged unevenly. This uneven arrangement of the surrounding fibers is considered to be the cause of the rapid increase in the multiformity.

In addition, if the clad diameter of the center fiber 11 is too large, the distance between the core of the center fiber 11 and that of the respective surrounding fiber becomes large. As a result, in order to branch the injected light from the center fiber 11 to the surrounding fibers, the coupling length of the fibers must be increased. This causes the size of the coupler to increase. Therefore, it is desirable that the diameter of the center fiber 11 not be set too large, and that the clad diameter difference ΔCLD be set below 100 μm. The same holds true for the case in which n is different from eight.

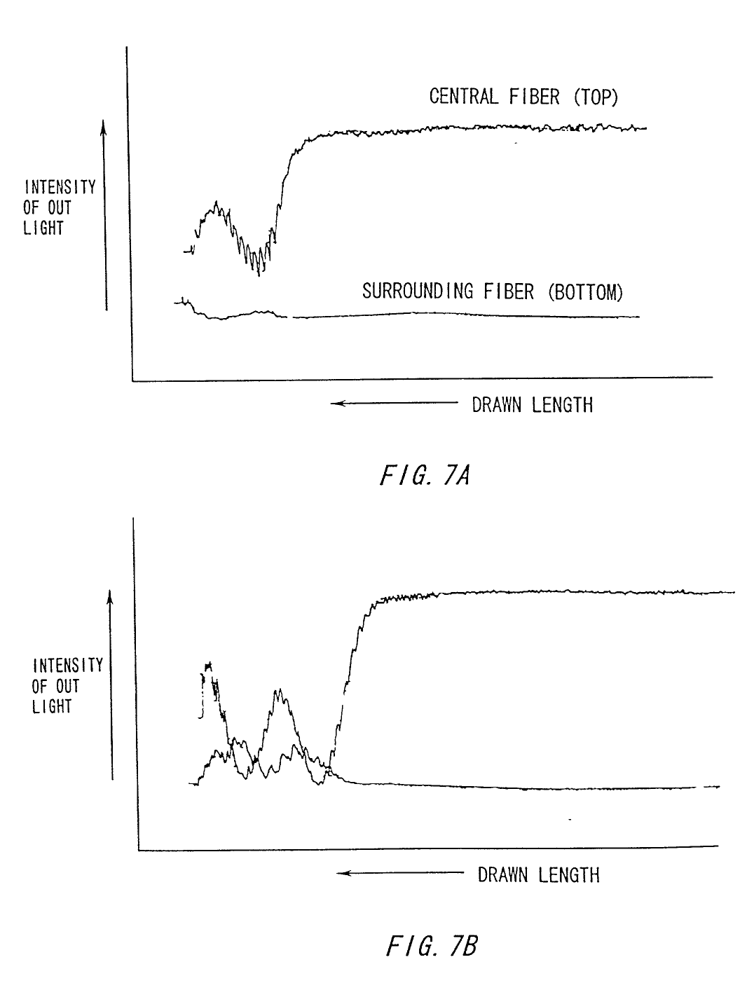

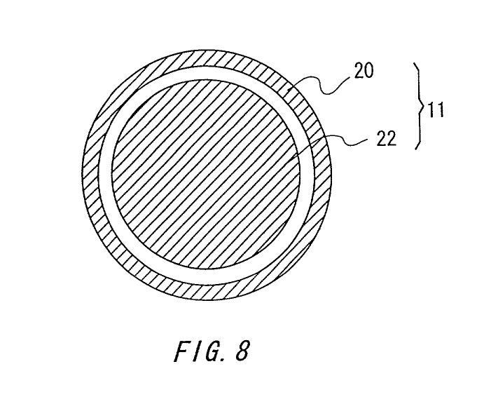

FIG. 7A shows the changes in intensities of the light output from the center fiber 11 and monitored surrounding fiber with respect to the drawn length of the center fiber in the case where the propagation constant βC of the center fiber differs greatly from the propagation constant βs of the surrounding fibers. FIG. 7B shows the changes in intensities of the light output from the center fiber 11 and monitored surrounding fiber with respect to the drawn length of the center fiber for the case in which the propagation constant βC of the center fiber is approximately equal to the propagation constant βs of the surrounding fibers.

Comparing FIG. 7A with FIG. 7B, it is clear that the light injected into the center fiber 11 does not sufficiently transfer to the surrounding fibers when the difference between the propagation constant βc of the center fiber and the propagation constant βsof the surrounding fibers is large. Here, the propagation constants βC and βs depend on the refractive index distribution profiles of the center fiber 11 and the monitored surrounding fiber, respectively. However, in the case of a step-type optical fiber whose refractive indices n1 and n0 of the core and clad, respectively, are constant inside its core and clad, respectively, the propagation constants β of the step-type optical fiber can be expressed by the following equations.

J0 (u) /u·J1 (u)=K0(w) /w·K1(w) (3)

u²+w²=v² (4)

where

u=Ak²(n1)²−β² (5)

w=Aβ²−k²n0² (6)

v²=k²(n1²−n0²)A² (7)

Here, A represents the core diameter of the step-type optical fiber. k represents the wave number of the light wave that pass through the step-type optical fiber. Jn(x) represents the Bessel function of the first kind of n-th order. Kn(x) represents the Bessel function of the second kind of n-th order. Hence, the propagation constant β is a function that is determined by the core diameter A, the refractive indices n1 and n0 of the core and clad of the step-type fiber, respectively, the wave number k of the light that passes through the step-type fiber, and the distribution profiles of the refractive indices n1 and n0 of the step-type fiber. If the center fiber 11 and surrounding fibers are produced from the same fiber pre-form in such a manner that only the clad diameter of the center fiber differs from that of the respective surrounding fiber, the core diameter of the center fiber 11 becomes different from that of the respective surrounding fiber.

As a result, the propagation constant βs of the respective surrounding fiber becomes different from the propagation constant βc of the center fiber 11. In this case, the center fiber 11 does not transfer the injected light by a sufficient amount to the surrounding fibers. In this case, it is necessary to equalize the propagation constant βs of the respective surrounding fiber with the propagation constant βc of the center fiber. The structural parameters of the respective surrounding fiber (the core diameter As of the monitored surrounding fiber, the refractive indices n1s and n0s of the core and clad of the monitored surrounding fiber, respectively, and the distribution profiles of the refractive indices n1s and n0s of the monitored surrounding fiber) or the structural parameters of the center fiber 11 (the core diameter Ac of the center fiber 11, the refractive indices n1c and n0c of the core and clad of the center fiber 11, respectively, and the distribution profiles of the refractive indices n1s and n0s of the center fiber 11) need to be adjusted.

In addition, an optical fiber has a cutoff wavelength λc that is determined by its structural parameters. If light whose wavelength is shorter than the cutoff wavelength λc of the optical fiber is injected, the optical fiber does not always operate by single mode. For example, in using light whose wavelength is 1310 nm, it is desirable that the cutoff wavelength of the optical fiber be shorter than 1310 nm and set to, for example, 1250 nm. In designing a standard optical fiber in this case, the core diameter A and relative refractive index Δn or the like of the optical fiber are usually adjusted so that the cutoff wavelength λc of the optical fiber will become 1250 nm. In designing a multi-branching optical coupler of the present invention also, it is desirable that the center fiber 11 should have substantially the same cutoff wavelength as the surrounding fibers.

The cutoff wavelength λc of an optical fiber is a function that is determined by the refractive indices n0 and n1 of its clad and core diameter, respectively, the distribution profiles of its refractive indices n0 and n1, respectively, and its core diameter A. For example, the cutoff wavelength λc of a step-type optical fiber can be expressed by the following equation.

λc=2.61356a((n1)²−(n0)²)^{½} (8)

Therefore, in this case, the cutoff wavelength λcc of the center fiber can be made equal to the cutoff wavelength λcs of each of the surrounding fibers by making the core diameter Ac of the center fiber, the refractive index n1c of the core of the center fiber, the refractive index n0c of the clad of the center fiber equal to the core diameter As of the respective surrounding fiber, the refractive index n1s of the core of the respective surrounding fiber, and the refractive index n0s of the clad of the respective surrounding fiber, respectively.

In order for the center fiber 11 and the surrounding fibers to have substantially the same propagation constant β and cutoff wavelength λc, the proportion of the core diameter of the center fiber 11 with respect to the clad diameter of the center fiber 11 is set smaller than the corresponding proportion of a standard single mode fiber, (that is, the proportion of the core diameter of the respective surrounding fiber with respect to the clad diameter of the respective surrounding fiber) at the pre-form stage of the center fiber 1. For example, suppose that eight identical fibers whose core diameters are all 9 μm have been manufactured from a pre-form having an clad diameter of 125 μm to be used as surrounding fibers of an 8-branching optical coupler.

Another clad is installed around the clad of this pre-form so as to change in advance the proportion of the core diameter with respect to the incremented clad diameter. For example, when the clad diameter has reached 168 μm, a new pre-form is manufactured. In this case, the core diameter of the new pre-form is 9 μm, which is equal to the core diameter of the respective surrounding fiber. This new pre-form is used to manufacture the center fiber 11. In this case, the center fiber 11 has the same the core diameter, relative refractive index Δn, and refractive index profile as the surrounding fibers. As a result, the center fiber 11 has the same propagation constant β as the surrounding fibers.

FIG. 8 shows another method for increasing the clad diameter of the center fiber 11. A base fiber 22 is inserted into a pipe 20 whose refractive index is less than or equal to the refractive index of the clad of the base fiber 22. Next, the pipe 20 is heated and drawn in the axial direction. As a result, the pipe 20 collapses inward in the radial direction, and is attached tightly to the base fiber 22. In this way, the center fiber 11 is manufactured. This method of attaching the pipe 20 tightly to the base fiber 22 is called a collapse. As a result, the clad diameter CLDc of the center fiber 11 can be increased without significantly changing its core diameter, relative refractive index Δnc, or refractive index profile.

As equation (1) shows, the relation between the clad diameter of the surrounding fiber and that of the center fiber 11 is invertible. Therefore, the above-described process may be reversed as follows. For example, a standard communication fiber whose clad diameter is 125 μm may be used for the center fiber 11. In this case, the clad diameter of the respective surrounding fiber is reduced by a heating and drawing process or a chemical etching process using a mixture solution of hydrofluoric acid and sulfuric acid. For example, if the clad diameter of the center fiber 11 is 125 μm, the clad diameter of the respective surrounding fiber can be set to 90 μm in accordance with equation (1). However, the result of thinning the surrounding fibers is that the clad diameters of the surrounding fibers tend to vary. Therefore, in order to branch the injected light from the center fiber 11 evenly into the surrounding fibers, it is desirable that the clad diameter of the center fiber 11 be increased without decreasing the clad diameter of the surrounding fibers.

Instead of equalizing the clad diameter of the center fiber 11 with that of the respective surrounding fiber, as an alternative method, the refractive index of the core of the center fiber 11 or that of the respective surrounding fiber may be changed. By changing the refractive index of the core of the center fiber 11 or that of the respective surrounding fiber, the cutoff wavelength λcc of the center fiber 11 can be set equal to the cutoff wavelength λcs of the surrounding fiber. In this way, the degree of incompleteness of the optical coupling can be reduced even if the diameter of the core of the center fiber 11 differs from that of the respective surrounding fiber. The 1 input×8 outputs optical coupler has been explained in detail in the above. However, the number of output fibers is not restricted to eight. In particular, in the case of optical couplers having less than or equal to seven (n≦7) output fibers, fibers having the same clad diameter can be used for both the center fiber 11 and surrounding fibers.

When the center fiber 11 is manufactured using a pre-form whose relative refractive index difference Δn and refractive index distribution profile differ slightly from the relative refractive index difference Δn and refractive index distribution profile of the pre-form from which the surrounding fibers are manufactured, the relative refractive index difference Δn and refractive index distribution profile of the center fiber 11 will differ from those of the surrounding fibers.

In this case, the core diameter, the mode field diameter (the diameter of a region of the fiber in which the light intensity is 1/e² of the maximum light intensity, referred to as the MFD), and the cutoff wavelength λcs of the respective single mode fiber (surrounding fiber) are adjusted so that they will approximately match the core diameter, mode field diameter and cutoff wavelength λcc of the center fiber. In this way, the propagation constant βs (or V value) of the respective surrounding fiber can be made approximately equal to the propagation constant βc (or V value) of the center fiber 11.

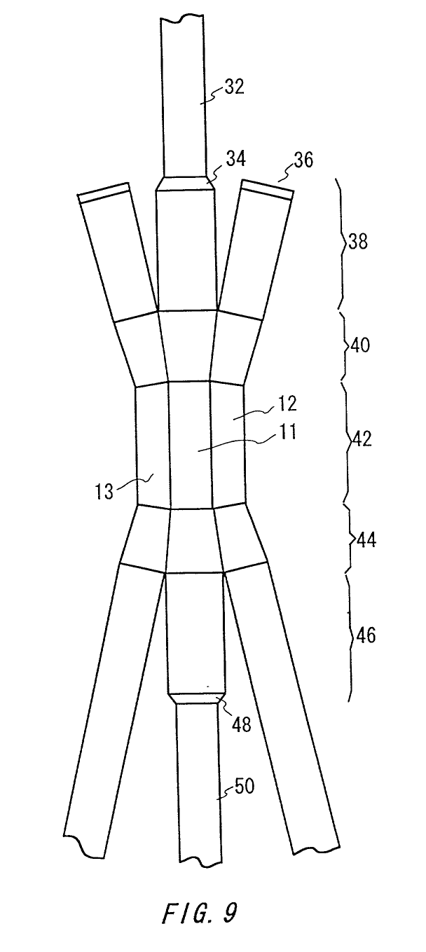

FIG. 9 shows an optical coupler unit made using a center fiber 11 and two surrounding fibers 12 and 13 by heating and drawing the fibers. The completed optical coupler unit has a coupled region 42 formed by completely fusing the surrounding fibers 12 and 13 with the center fiber 11. In addition, the completed optical coupler unit has extension regions 38 and 46 on the two sides, respectively, of the coupled region 42 in the axial direction. In the extension regions 38 and 46, the surrounding fibers 12 and 13 have not been drawn. A first tapered portion 40 is formed between the coupled region 42 and the extension region 38. A second tapered portion 44 is installed between the coupled region 42 and the extension region 46. In the tapered portions 40 and 44, the center fiber 11 and surrounding fibers 12 and 13 are tapered from the extension regions 38 and 46 respectively, toward the coupled region 42. In addition, the incident light side ends 36 of the surrounding fibers 12 and 13 are made non-reflective in order to suppress the light reflection amount from the ends 36 of the surrounding fibers 12 and 13.

As is clear from FIG. 9, the center fiber 11 has an input end 34 to which light is input and an output end 48 from which the light is output. The light input to the input end 34 of the center fiber 11 is output and branches out to the output end 48 of the center fiber 11 and the surrounding fibers 12 and 13. The core of the center fiber 11 extends from the light input end 34 to the light output end 48. A clad is installed around this core. For ease of explanation, only one center fiber 11 and two surrounding fibers 12 and 13 are shown in FIG. 9. However, additional surrounding fibers may be installed evenly around the center fiber 11.

A fiber whose clad diameter is 125 μm is used for a standard optical communication. When the clad diameter of the center fiber 11 differs from that of the respective surrounding fiber, the clad diameter of the center fiber 11 or the clad diameter of the respective surrounding fiber differs from the clad diameter of the fiber used for a standard optical communication. In this case, a fiber having the standard clad diameter, 125 μm, which is used for a standard optical communication may be connected in advance or afterwards to the fiber(s) whose clad diameter differs from the clad diameter of the fiber used for a standard optical communication. As FIG. 9 shows, when the clad diameter of the center fiber 11 is larger than that of the fiber used for standard optical communication, standard single mode fibers 32 and 50 whose clad diameters are smaller than the clad diameter of the center fiber 11 are connected to the ends 34 and 48 of the center fiber 11.

When the clad diameters of the surrounding fibers 12 and 13 are smaller than the clad diameters of the fiber used for standard optical communication, a standard single mode fiber whose clad diameter is larger than the clad diameters of the surrounding fibers 12 and 13 is connected to the light output side of each of the surrounding fibers 12 and 13. When the ends of the multi-branching optical coupler are required to be tape fibers, the output side center fiber 11 is connected to a first tape fibers and the output side surrounding fibers 12 and 13 are connected to second and tape fibers. In this way, a fiber whose clad diameter is 125 μm is connected to at least one end of the center fiber or one of the surrounding fibers. As a result, a widely applicable multi-branching optical coupler can be provided. In order to increase the strength of the multi-branching optical coupler, it is desirable that the multi-branching optical coupler unit shown in FIG. 9 be covered by a rigid body such as a metal tube or the like.

1. First Example

Four identical optical fibers whose diameters are 125 μm were prepared. A portion of the coating that covers each of these fibers was removed. One of the four fibers was used as a center fiber 11. The remaining three fibers were attached on the circumference of the center fiber 11, creating a fiber bundle. In this case, the surrounding fibers were separated from each other by the same distance. This fiber bundle was drawn heating the portion where the surrounding fibers were attached to the center fiber by oxyhydrogen flame.

This drawing process was carried out supplying light to one end of the center fiber 11, and monitoring the output from the center fiber 11 and the output from one of the three surrounding optical fibers. The heating-fusing-drawing process was stopped when the light branching ratio became 25%. The manufactured multi-branching coupler wire was fixed with resin onto a quartz glass substrate, and was stored in a cylindrical metal case. As a result, an equi-branching coupler whose branching ratio is 25% was obtained. The size of the case of this coupler is 3.5 mm (diameter)×65 mm (length). Since the fibers were batch-fused, this coupler can be stored in a coupler case whose size is approximately the same as that of a standard coupler case.

2. Second Example

Four identical optical fibers whose diameters are 125 μm were prepared. A portion of the coating that covers each of these fibers was removed. One of the four fibers was used as a center fiber 11. The remaining three fibers 12, 13, and 14 were attached to the circumference of the center fiber 11 using a jig 25 shown in FIG. 3, creating a fiber bundle. In this case also, the surrounding fibers 12, 13, and 14 were separated from each other by the same length. The fibers 11, 12, 13, and 14 were arranged parallel to the longitudinal direction without being twisted. This fiber bundle was drawn heating the portion where the surrounding fibers were attached to the center fiber by oxyhydrogen flame.

This extension process was carried out supplying light to one end of the center fiber 11, and monitoring the output from the output end of the center fiber 11 and the output from one of the three surrounding optical fibers. The heating-drawing process was stopped when the intensity of the light output from the center fiber 11 became equal to the intensity of the light output from the monitored surrounding fiber. The resultant multi-branching coupler wire was fixed with resin onto a quartz glass substrate, and was stored in a cylindrical metal case. As a result, an equi-branching coupler whose branching ratio is 25% was obtained. The size of the case of this coupler is 3.5 mm (diameter)×65 mm (length). Since the fibers were batch-fused, this coupler can be stored in a coupler case whose size is approximately the same as that of a standard coupler case.

3. Third Example

Seven surrounding optical fibers (core diameter 9 μm, clad diameter 125 μm) were attached tightly onto the circumference of a center fiber 11 (core diameter 9 μm, clad diameter 168 μm) as shown in FIG. 4A, forming a fiber bundle. This fiber bundle was heated, fused, and drawn as in the first embodiment. The wavelength of the input light was 1550 nm, and the light branching ratio was 100/8. In this case, the propagation constant of the center fiber 11 was made equal to that of the respective surrounding fiber by making the refractive index profile of the core of the center fiber 11 equal to that of the respective surrounding fiber.

FIG. 9 shows the output characteristics of the manufactured 8-branching optical coupler. A 1×8 coupler having low insertion loss and small multiformity has been produced. The PDL of this coupler was measured. The PDL of each of the output ports was about 0.1 dB. Thus, the PDL (Polarization Dependent Loss) of this coupler has been confirmed to be low.

4. Fourth Example

Seven surrounding optical fibers (core diameter 9 μm, clad diameter 125 μm) and a center fiber 11 (core diameter 9 μm, clad diameter 168 μm) were prepared. A portion of the coating that covers each of these fibers was removed. The seven surrounding optical fibers were attached tightly onto the circumference of the center fiber 11, separating the seven surrounding optical fibers by the same distance from each other. In this way, a fiber bundle was formed. The center fiber 11 and surrounding fibers have been manufactured based on the same pre-form. Hence, the center fiber has the same refractive index profile, relative refractive index, and cutoff wavelength as the surrounding fibers.

The set of seven surrounding fibers and the center fiber 11 were then co-axially twisted about each other in opposite directions for three full rotations. The portion of the fiber bundle where the center fiber 11 is in contact with the surrounding fibers as a result of the co-axial twisting was then drawn as it was heated with oxyhydrogen flame. This drawing process was carried out supplying light to one end of the center fiber 11, and monitoring the output from the output end of the center fiber 11 and the output from arbitrary one of the seven surrounding optical fibers.

The heating-fusing-drawing process was stopped when the intensity of the light output from the center fiber 11 became equal to the intensity of the light output from the selected monitored surrounding fiber. The resultant multi-branching coupler wire was fixed with resin onto a quartz glass substrate, and was stored in a cylindrical metal case. In this way, an 8-branching coupler has been obtained. The size of the case of this coupler turned out to be 3.5 mm (diameter)×75 mm (length). This size is much smaller than the size of a multi-step connected coupler case.

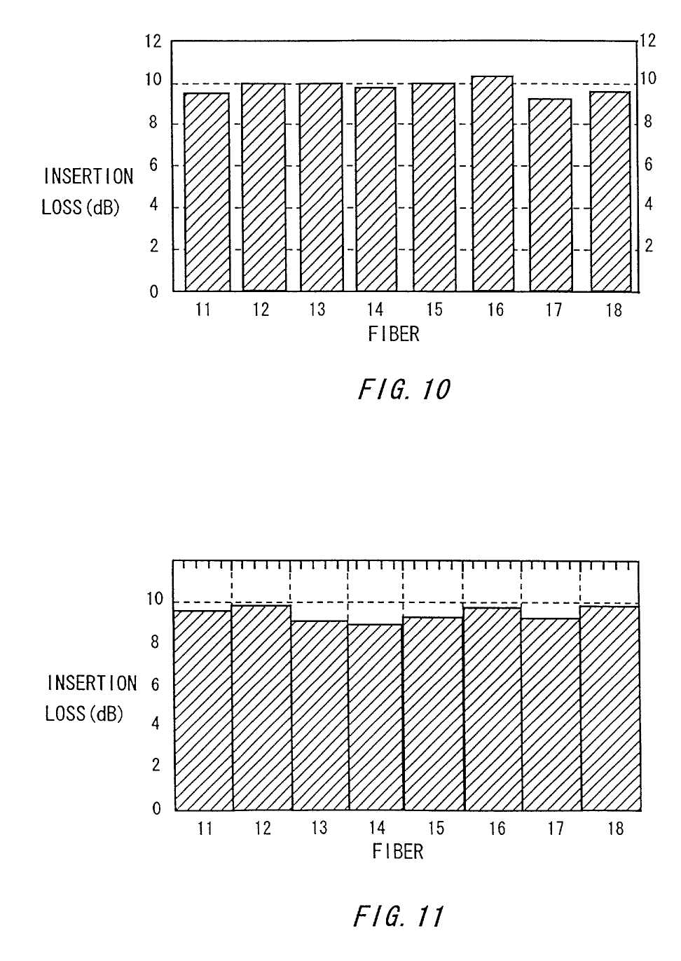

FIG. 10 shows the insertion loss in each output port (each fiber) of this 8-branching optical coupler. The insertion loss in each port has turned out to be as follows. Port 1 (center fiber): 9.63 dB. Port 2 (surrounding fiber 12): 9.88 dB. Port 3 (surrounding fiber 13): 9.14 dB. Port 4 (surrounding fiber 14): 8.99 dB. Port 5 (surrounding fiber 15): 9.56 dB. Port 6 (surrounding fiber 16): 9.79 dB. Port 7 (surrounding fiber 17): 9.48 dB. Port 8 (surrounding fiber 18): 9.90 dB. The maximum insertion loss was 9.90 dB, and the multiformity was 0.91 dB. This shows that the manufactured multi-branching optical coupler has a satisfactory output balance.

The measurement of the PDL (Polarization Dependent Loss) of the manufactured multi-branching optical coupler has turned out to be less than 0.2 dB. This confirms that the manufactured multi-branching optical coupler has a low PDL. Moreover, the temperature dependency of the manufactured multi-branching optical coupler was also measured in the range between −40°C. and +85°C. The variation of the insertion loss in this temperature range has turned out to be less than 0.2 dB. This confirms that the insertion loss of the manufactured multi-branching optical coupler is stable, that is, the manufactured multi-branching optical coupler has been confirmed to have a stable environmental characteristics.

The clad diameter of the output end of the respective surrounding fiber of the 8-branching optical coupler that has been manufactured by the above-described method is 125 μm, which is a standard size. However, the clad diameter of the center fiber 11 is 168 μm, which is large. Therefore, it is inconvenient to connect the center fiber to a standard 125 μm fiber. To rectify this problem, a standard 125 μm connection fiber was fused by arc discharge and connected to each of the two ends of the center fiber 11 in advance. This composite of the center fiber 11 and the connection fiber was heated and drawn together with the surrounding fibers. The core diameters of all the fibers have been designed to be almost identical. As a result, the connection losses at the end surfaces of these fibers were small. Hence, the increase in the loss amount due to the fiber end surface connection was almost negligible.

Although the present invention has been described using its embodiments, the scope of the present invention is not limited to these embodiments. Those skilled in the art can add various modifications and improvements to the embodiments of the present invention. It is clear from the claims that such modified or improved embodiments can be also covered by the scope of the present invention. In particular, the total number of branching fibers suffices to be greater than or equal to two, and is not limited to eight or four as described in the embodiments of the present invention. This patent application claims priority based on Japanese patent applications, H9-173371 filed on Jun. 30, 1997 and No. H9-266244 filed on Sep. 30, 1997, the contents of which are incorporated herein by reference.

As is clear from the above explanation, according to the multi-branching optical coupler of the present invention, light can be branched equally to all the branching fibers. In addition, since the arrangement of the optical fibers is simple, the multi-branching optical coupler of the present invention can be easily manufactured.

What is claimed is:

1. A multi-branching optical coupler for branching input light into a plurality of fibers, comprising:
a center fiber having an input end to which said input light is input and an output end; and
a plurality of surrounding fibers installed around said center fiber,
wherein said input light input to said input end of said center fiber is branched into said output end of said center fiber and said surrounding fibers.

2. A multi-branching optical coupler as claimed in claim 1, wherein said center fiber has a core which extends from said input end to said output end and a clad formed on said core.

3. A multi-branching optical coupler as claimed in claim 1, wherein each of said surrounding fibers has a coupled region that is fused with said center fiber.

4. A multi-branching optical coupler as claimed in claim 3 wherein said surrounding fibers are placed on circumference of said center fiber such that said surrounding fibers are separated from each other by substantially a same distance.

5. A multi-branching optical coupler as claimed in claim 4, wherein said center fiber and said surrounding fibers are installed substantially parallel and linearly.

6. A multi-branching optical coupler as claimed in claim 4, wherein said surrounding fibers are twisted about said center fiber in said coupled region keeping said distance between adjacent surrounding fibers.

7. A multi-branching optical coupler as claimed in claim 3, further comprising:
a tapered portion that is formed outside of said coupled region in an axial direction of said center fiber, said tapered portion having a partial cone shaped center fiber and partial cone shaped surrounding fibers, which have been formed by drawing said center fiber and surrounding fibers, respectively.

8. A multi-branching optical coupler as claimed in claim 1, wherein each of said surrounding fibers has two ends, one of said two ends being made non-reflective, and the branched light being output from other of said two ends.

9. A multi-branching optical coupler as claimed in claim 1, wherein each of said surrounding fibers has two ends, further comprising a tape-type fiber connected to one of said two ends.

10. A multi-branching optical coupler as claimed in claim 1, wherein at least one of said surrounding fibers is fused with at least one of said other surrounding fibers.

11. A multi-branching optical coupler as claimed in claim 1 wherein none of said surrounding fibers is fused with other surrounding fibers.

12. A multi-branching optical coupler for branching input light into a plurality of fibers, comprising:
a center fiber positioned at a center of said plurality of fibers;
a plurality of surrounding fibers installed around said center fiber, distances between two adjacent surrounding fibers being substantially equal, said center fiber and each of said surrounding fibers having a core and a clad formed on said core; and
a coupled region in which said clad of each of said surrounding fibers is fused with said clad of said center fiber.

13. A multi-branching optical coupler as claimed in claim 12 wherein a total number n of said center fiber and surrounding fibers is greater than seven, and a diameter CLDc of said clad of said center fiber is larger than a diameter CLDs of said clad of said surrounding fibers.

14. A multi-branching optical coupler as claimed in claim 13 further comprising an extension region outside of said coupled region in said axial direction, in which:
said center fiber and surrounding fibers are not drawn;
said surrounding fibers are not fused with said center fiber; and
said diameter CLDc, said diameter CLDs and said total number n satisfy a relation,
0≦CLDc−(CLDs/sin(π/(n−1))+CLDs≦100 μm.

15. A multi-branching optical coupler as claimed in claim 13, wherein said center fiber has:
a base fiber including a core and a clad formed on said core, a diameter of said base fiber being smaller than said diameter CLDc; and
a transparent pipe tightly attached to a circumference of said base fiber, said diameter of said transparent pipe being equal to said diameter CLDc,
wherein a refractive index of said transparent pipe is less than or equal to a refractive index of said clad of said base fiber.

16. A multi-branching optical coupler as claimed in claim 13, wherein said surrounding fibers have been made by reducing said clad diameter of a fiber initially having a same clad diameter as said center fiber.

17. A multi-branching optical coupler as claimed in claim 16 wherein a clad diameter of said surrounding fibers have been reduced by heating and drawing said surrounding fibers.

18. A multi-branching optical coupler as claimed in claim 16 wherein a clad diameter of said surrounding fibers has been reduced by chemically etching said clad of said surrounding fiber.

19. A multi-branching optical coupler as claimed in claim 13 wherein a cutoff wavelength of said center fiber is substantially equal to a cutoff wavelength of said surrounding fibers.

20. A multi-branching optical coupler as claimed in claim 13 wherein a propagation constant of said center fiber is substantially equal to a propagation constant of said surrounding fibers.

21. A multi-branching optical coupler as claimed in claim 13 wherein a clad diameter of said center fiber is substantially equal to said clad diameter of each of said surrounding fibers.

22. A multi-branching optical coupler as claimed in claim 13 wherein a relative refractive index of said center fiber is substantially equal to said relative refractive index of each of said surrounding fibers.

23. A multi-branching optical coupler as claimed in claim 13 wherein a mode field diameter of said center fiber is substantially equal to a mode field diameter of each of said surrounding fibers.

24. A multi-branching optical coupler as claimed in claim 13 wherein said center fiber has two ends, further comprising:
a connection fiber connected to at least one of said two ends, a clad diameter of said connection fiber being smaller than said diameter of said center fiber.

25. A multi-branching optical coupler as claimed in claim 13 wherein each of said surrounding fibers has two ends, further comprising:
a connection fiber connected to at least one of said two ends of said surrounding fibers, a clad diameter of said connection fiber being larger than said clad diameter of said surrounding fibers.

26. A method of making a multi-branching optical coupler having a center fiber and surrounding fibers arranged about said center fiber for branching input light into at least said surrounding fibers, comprising the steps of:
preparing a center fiber having an input side to which said input light is input and an output side from which one of the branched light is output;
preparing an openable regular polygonal case, a corner number of which being equal to a number of said surrounding fibers;
placing one of said surrounding fibers at each of two successive corners of said openable regular polygonal case;
placing said center fiber on said surrounding fibers placed at said two successive corners;
placing said remaining surrounding fibers at said remaining corners of said regular polygonal case;
closing said regular polygonal case; and
fusing said surrounding fibers with said center fiber by heating and drawing said fiber bundle in said axial direction of said center fiber.
